(19) United States
(12) Patent Application Publication
(10) Pub. No.: US 2013/0011258 A1
(43) Pub. Date: Jan. 10, 2013

(54) Wind turbine with gale protection

(75) Inventor: Hai Pin Kuo, Tainan (TW)

(73) Assignee: Sports Art Industrial Co., Ltd.

(21) Appl. No.: 13/135,406

(22) Filed: Jul. 5, 2011

(51) Int. Cl. F03D 7/02

(52) U.S. Cl. 416/11

(57) ABSTRACT

A wind turbine includes a nacelle pivotally supported on top of a tower and having a tail rod, a rotator blade device mounted to the nacelle, a tail vane extended from the tail rod, two horizontal stabilizers mounted to the sides of the tail vane, a stable flap attached to the tail rod and located below one of the horizontal stabilizers, and a pivotal flap pivotally attached to the tail rod and located below the other horizontal stabilizer and pivotal relative to the tail vane to selectively engage with the horizontal stabilizer by a strong wind, and to generate a side force onto the tail vane, and to pivot the wind turbine and to deviate the wind turbine from a headwind and to prevent the wind turbine from being over-rotated or burned or damaged by the gale or strong wind.

### BACKGROUND OF THE INVENTION

1. Field of the Invention

The present invention relates to a wind turbine, and more particularly to a wind turbine including a gale protection arrangement or mechanism for protecting and preventing the wind turbine from facing the gale and for preventing the wind turbine from being over-rotated or burned or damaged by the gale or strong wind.

2. Description of the Prior Art

Typical wind turbines comprise a nacelle pivotally or rotatably supported on top of a tower, and one or more rotator blades pivotally or rotatably attached or mounted or secured onto the tower and connected or coupled to the motor or the generator for rotating or driving or actuating the motor or generator to generate an electric energy or power.

For example, U.S. Pat. No. 4,517,467 to Fuhring discloses one of the typical wind turbines comprising a single rotor blade for rotating or driving or actuating an alternator whose output is connected to an a-c network to supply same with power when the alternator acts as a generator operated under the driving force of the wind, and changing the pitch of the blade allows a wide range of wind velocities to be accommodated.

However, when the pitch of the blade is changed, the pivotal coupling mechanism of the nacelle to the tower may be twisted or damaged, and the working life of the typical wind turbine may be greatly reduced.

The present invention has arisen to mitigate and/or obviate the afore-described disadvantages of the conventional gale protections for the wind turbines.

### SUMMARY OF THE INVENTION

The primary objective of the present invention is to provide a wind turbine including a gale protection arrangement or mechanism for protecting and preventing the wind turbine from facing the gale and for preventing the wind turbine from being over-rotated or burned or damaged by the gale or strong wind.

In accordance with one aspect of the invention, there is provided a wind turbine comprising a nacelle pivotally supported on top of a tower, the nacelle including a tail rod extended rearwardly from the nacelle, a rotator blade device pivotally mounted onto the nacelle, a tail vane extended upwardly from the tail rod, and including a first side and a second side, a first horizontal stabilizer mounted to the first side of the tail vane, and a second horizontal stabilizer attached to the second side of the tail vane, a stable flap located below the second horizontal stabilizer, and a pivotal flap located below the first horizontal stabilizer and selectively pivotal relative to the tail vane and to selectively engage with the first horizontal stabilizer by a strong wind, and to generate a side force onto the tail vane, and to pivot or rotate the wind turbine sidewise, and to deviate the wind turbine from a headwind, and for preventing the wind turbine from being over-rotated or burned or damaged by the gale or strong wind.

The stable flap is solidly and stably attached to the tail rod and located below the second horizontal stabilizer, and may not be moved or pivoted or rotated relative to the tail vane.

The pivotal flap includes a first end pivotally attached to the tail rod with a pivot shaft, and includes a second end selectively engageable with the first horizontal stabilizer when the pivotal flap is pivoted or rotated relative to the tail vane.

The tail rod includes a stop for selectively engaging with the pivotal flap and for limiting the pivotal flap to pivot relative to the tail vane and for preventing the pivotal flap from being over-rotated relative to the tail vane and the tail rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a wind turbine in accordance with the present invention;

FIG. 2 is a partial plan schematic view illustrating the tail portion of the wind turbine; and

FIG. 3 is a partial plan schematic view similar to FIG. 2, illustrating the actuation or operation of the tail portion of the wind turbine.

### DETAILED DESCRIPTION OF THE PREFERRED EMBODIMENT

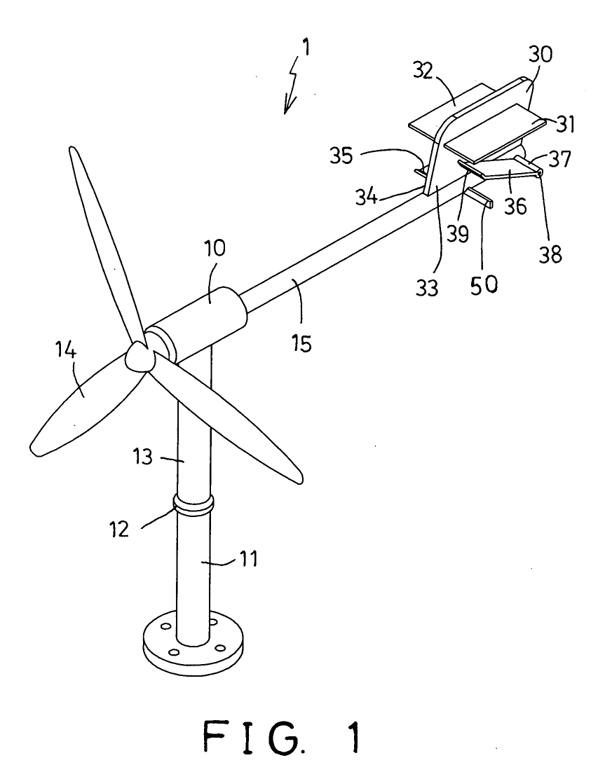

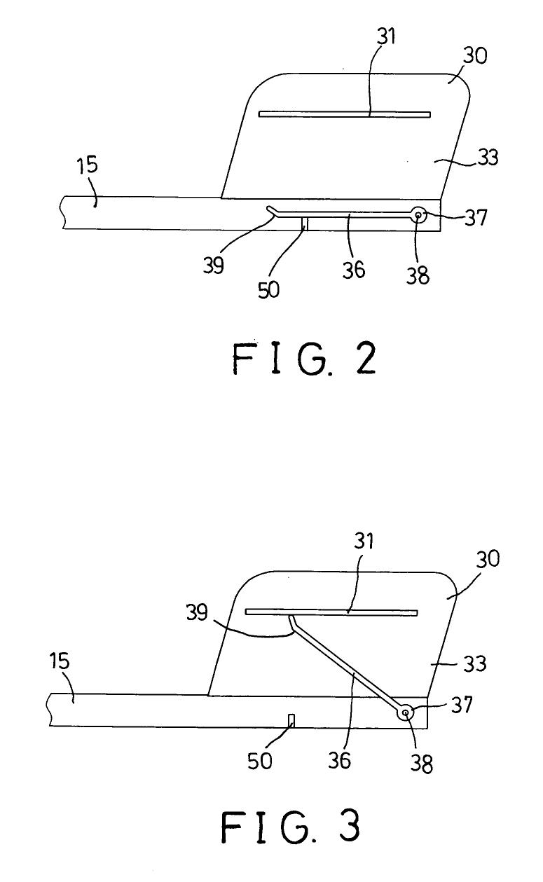

Referring to the drawings, and initially to FIGS. 1 and 2, a wind turbine 1 in accordance with the present invention comprises a mounting tube or nacelle 10 pivotally or rotatably attached or mounted or secured or supported on top of a tower 11 with a pivot axle or journal bearing 12, for example, the nacelle 10 may be directly and pivotally or rotatably attached or mounted or secured or supported on top of the tower 11, or may include a stud 13 extended downwardly therefrom for pivotally or rotatably attaching or mounting or securing or supporting on top of the tower 11 with the pivot axle or journal bearing 12, for receiving or accommodating a motor or electric generator or the like (not shown) and the other electric parts or elements (not shown) therein.

The wind turbine 1 further includes one or more rotator blades or a rotator blade device 14 pivotally or rotatably attached or mounted or secured onto the nacelle 10 and connected or coupled to the motor or electric generator (not shown) for rotating or driving or actuating the motor or generator to generate an electric energy or power. The above-described structure or configuration including the nacelle 10, the pivot axle or journal bearing 12, the stud 13, and rotator blade device 14 is typical and is not related to the present invention and will not be described in further details. The wind turbine 1 further includes a tail rod 15 extended rearwardly from the nacelle 10.

The wind turbine 1 further includes a tail vane 30 extended upwardly from the tail rod 15, a first or left horizontal elevator or stabilizer 31 and a second or right horizontal elevator or stabilizer 32 attached or mounted or secured onto the tail vane 30, or two horizontal elevators or stabilizers 31, 32 attached or mounted or secured onto the two sides 33, 34 of the tail vane 30 respectively. A fixed or stable flap 35 is solidly and stably attached or mounted or secured onto one of the sides 34 of the tail vane 30 or of the tail rod 15 and located below the second or right horizontal elevator or stabilizer 32, and a movable or pivotal flap 36 attached or mounted or secured onto the other side 33 of the tail vane 30 or of the tail rod 15 and located below the first or left horizontal elevator or stabilizer 31.

For example, the pivotal flap 36 includes one end or first or rear end 37 pivotally or rotatably attached or mounted or secured onto the tail vane 30 or the tail rod 15 with a pivot shaft 38, and includes the other end or second or front end or portion 39 contactable or engageable with the first or left horizontal elevator or stabilizer 31 selectively (FIG. 3). A key or latch or stop 50 is attached or mounted or secured onto the tail vane 30 or the tail rod 15 for selectively engaging with the pivotal flap 36 and for limiting the pivotal flap 36 to pivot or rotate relative to the tail vane 30 and the tail rod 15 and for preventing the pivotal flap 36 from being over-rotated relative to the tail vane 30 and the tail rod 15.

In operation, as shown in FIGS. 1 and 2, when heading a relatively slower wind or a steady wind, the pivotal flap 36 may be pivoted or rotated downwardly to contact or engage with the stop 50 for allowing the wind turbine 1 to be stably and steadily faced or headed toward the wind. As shown in FIG. 3, when a gale or strong wind is generated or occurred and when the driving force of the wind is large enough to pivot or rotate the pivotal flap 36 relative to the tail vane 30 and the tail rod 15, the other end or second or front end or portion 39 the pivotal flap 36 may be caused or forced to selectively contact or engage with the first or left horizontal elevator or stabilizer 31, and to generate a side force onto or against or toward the tail vane 30 and the tail rod 15, and to pivot or rotate the tail vane 30 and the tail rod 15 and the wind turbine 1 sidewise, and thus to offset and to drift off the headwind or to deviate the wind turbine 1 from the headwind, and to protect and prevent the wind turbine 1 from facing the gale or strong wind and for preventing the wind turbine 1 from being over-rotated or burned or damaged by the gale or strong wind.

Accordingly, the wind turbine in accordance with the present invention includes a gale protection arrangement or mechanism for protecting and preventing the wind turbine from facing the gale and for preventing the wind turbine from being over-rotated or burned or damaged by the gale or strong wind.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wind turbine comprising:
a nacelle pivotally supported on top of a tower, said nacelle including a tail rod extended rearwardly from said nacelle,
a rotator blade device pivotally mounted onto said nacelle,
a tail vane extended upwardly from said tail rod, and including a first side and a second side,
a first horizontal stabilizer mounted to said first side of said tail vane, and a second horizontal stabilizer attached to said second side of said tail vane,
a stable flap located below said second horizontal stabilizer, and
a pivotal flap located below said first horizontal stabilizer and selectively pivotal relative to said tail vane and to selectively engage with said first horizontal stabilizer by a strong wind, and to generate a side force onto said tail vane, and to pivot said wind turbine and to deviate said wind turbine from a headwind.

2. The wind turbine as claimed in claim 1, wherein said stable flap is attached to said tail rod and located below said second horizontal stabilizer.

3. The wind turbine as claimed in claim 1, wherein said pivotal flap includes a first end pivotally attached to said tail rod with a pivot shaft, and includes a second end selectively engageable with said first horizontal stabilizer.

4. The wind turbine as claimed in claim 1, wherein said tail rod includes a stop for selectively engaging with said pivotal flap and for limiting said pivotal flap to pivot relative to said tail vane.
